(19) United States
(12) Patent Application Publication
(10) Pub. No.: US 2025/0100791 A1
(43) Pub. Date: Mar. 27, 2025

(54) REGOLITH CARTRIDGE

(71) Applicant: Astroport Space Technologies, Inc., SAN ANTONIO, TX (US)

(72) Inventors: Samuel Ximenes, San Antonio, TX (US); Hardev Singh, San Antonio, TX (US)

(73) Assignee: Astroport Space Technologies, Inc., SAN ANTONIO, TX (US)

(21) Appl. No.: 18/892,292

(22) Filed: Sep. 20, 2024

Related U.S. Application Data
(60) Provisional application No. 63/540,030, filed on Sep. 22, 2023.

(51) Int. Cl. B65D 88/66; B01F 31/85; B01F 35/512; B01F 35/71; B01F 35/75; B25J 9/00

(52) U.S. Cl. CPC B65D 88/66; B01F 31/85; B01F 35/512; B01F 35/71805; B01F 35/7547; B25J 9/0009

(57) ABSTRACT

A container for storing and transporting regolith includes an upper portion having a top end that includes an inlet opening. An inlet valve is attached to the inlet opening and is configured for moving between a closed inlet position and an open inlet position. The container also has a lower portion continuous with the upper portion. The lower portion has sidewalls that taper inwards and terminate in a bottom end having an outlet opening. An outlet valve is attached to the outlet opening and is configured for moving between a closed outlet position and an open outlet position. The container further includes a robotic arm interface configured for being gripped by a robot. An inner surface of the container may include a non-stick coating so that the regolith does not adhere thereto.

### CROSS-REFERENCE TO RELATED APPLICATIONS

This Application claims priority to U.S. Provisional Patent Application No. 63/540,030 filed on Sep. 22, 2024, entitled “Regolith Cartridge,” the contents of which are incorporated herein by reference.

### BACKGROUND

### Field of the Art

The present invention relates generally to the field of construction material handling and more specifically to a container for handling and transportation of regolith in low-gravity environments, such as lunar or Martian surfaces.

### Discussion of the State of the Art

In any construction project, the excavation of soil is a critical step for creating the foundation of a structure. The excavated soil must be moved out of the construction site to make way for further development. This problem becomes particularly complex when dealing with regolith on celestial bodies like the Moon or Mars. Regolith, a layer of loose, fragmented material covering solid rock, serves as both the obstacle to be removed and the raw material for construction. The challenges are multi-faceted and complex as explained below.

Regolith is not uniformly sized; it consists of a mixture of fine particles, rocks, and other varying sizes of material. This variation in size complicates its use as a construction material, especially when specific particle sizes are required for processes like melting and 3D printing.

Unlike terrestrial soil, regolith particles are often electromagnetically charged, causing them to cling together and to other surfaces. This makes it difficult for the particles to settle and complicates their handling. The low-gravity conditions make traditional methods of moving soil, such as tipping a container to let gravity do the work, ineffective. Additionally, regolith particles are abrasive and can interfere with mechanical joints, adhere to spacesuits, and contaminate other equipment. Finally, transport mechanisms in inaccessible environments may be severely space constrained and traditional transportation systems and methods are too inefficient for transporting regolith on celestial surfaces.

The known methods suffer from various drawbacks, including inefficiency, high maintenance, risk of contamination, and lack of optimization for low-gravity environments. Currently, there are no methods or systems for efficient handling, sorting, and transporting regolith that addresses these challenges.

### SUMMARY

The present invention is for a cartridge that provides a solution for the handling, sorting, and transportation of regolith in low-gravity environments. The cartridge manages electromagnetically charged regolith particles to minimize contamination and abrasion (for example, adhesion to equipment and spacesuits), enables efficient transportation of sorted regolith between locations in a low-gravity environment (for example, efficiently loading and unloading regolith in a low-gravity environment, eliminating the need to rely on gravitational forces), optimizes the use of space within the hauling equipment (for example, optimizing the use of space within the hauling equipment, allowing for optimizing number of cartridges to be transported without wasting space), and optionally helps sort regolith particles based on size for suitability in construction processes (for example, focusing on particles not larger than 70 nm for optimal use in melting processes).

In one aspect, the cartridge (hereinafter, also referred to as a container) system is designed to interface with two separate systems: a silo interface that allows for the regolith to be pulled into the container, accounting for the lack of gravity, and a melter printer interface that enables the sorted regolith to be transferred directly into a melting pot, where it is liquefied and then used in a 3D printer to form construction materials like bricks.

A container designed for the efficient handling, storage, and transportation of regolith, especially in low-gravity environments features a cylindrical reservoir with a chamber and employs levitation technology to suspend and manage regolith particles. The interior walls of the cartridge can be electrified, activating inherent magnetic properties to induce levitation of the regolith. Additionally, the cartridge is equipped with electromagnetic nodes and an inducer mechanism that becomes magnetic upon receiving a charge. The design includes a top aperture for regolith entry and a bottom aperture for regolith exit. The cartridge's material is chosen for its smoothness and non-adhesive properties, facilitating regolith flow. A sealing mechanism ensures a secure seal, and the cartridge is constructed to fit snugly within transportation holders, ensuring stability during movement. The regolith container streamlines regolith management in challenging environments.

In one example, the invention is directed to a container for storing and transporting regolith. The container includes an upper portion and a lower portion continuous with the upper portion. The upper portion includes a top end having an inlet opening. An inlet valve is attached to the inlet opening and is configured for moving between a closed inlet position and an open inlet position. The lower portion includes sidewalls that taper inwards and terminate in a bottom end having an outlet opening. An outlet valve is attached to the outlet opening and is configured for moving between a closed outlet position and an open outlet position. The container also includes a robotic arm interface configured for being gripped by a robot. In one example, the container has an inner surface having a non-stick coating such as polytetrafluoroethylene. The container may further include a vibration mechanism configured to be selectively activated to cause the container to vibrate.

The inlet and outlet valves may be mechanically actuated valves. For example, the inlet and outlet valves may be iris valves or scissor valves. The inlet valve may have an inlet valve actuator and the outlet valve may have an outlet valve actuator. The inlet valve actuator and the outlet valve actuator may include handles that are configured for being operated by a robot or by mechanical engagement with other pieces of equipment. The inlet valve and the outlet valve may be biased to be in the closed inlet position and the closed outlet position, respectively.

In summary, the invention offers a cartridge system that addresses the challenges of handling, sorting, and transporting regolith in low-gravity environments, with specific interfaces for loading and unloading the material.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIGS. 1A and 1B are a perspective view and a cut away view, respectively, of a regolith container, in accordance with an embodiment of the present invention.

FIGS. 2A and 2B are perspective views of a regolith container in a closed position and an open position, respectively, in accordance with an embodiment of the present invention.

FIG. 2C illustrates a scissor valve in a closed position and an open position.

FIG. 3A is a perspective view of a silo, in accordance with an embodiment of the present invention.

FIG. 3B is a close up view of a bottom portion of a silo, in accordance with an embodiment of the present invention.

FIG. 3C illustrates a regolith container attached to a silo, in accordance with an embodiment of the present invention.

FIG. 4 is a perspective view of a plurality of regolith containers and a crate for holding the plurality of containers, in accordance with an embodiment of the present invention.

FIG. 5 illustrates a hauler for transporting a plurality of regolith containers, in accordance with an embodiment of the present invention.

FIG. 6 illustrates a regolith container positioned in a hopper of a brick making apparatus, in accordance with an embodiment of the present invention.

FIGS. 7A-7D illustrate electromagnetic systems, in accordance with an embodiment of the present invention.

### DETAILED DESCRIPTION

The present invention is a container for storing and transporting regolith in low-gravity environments. The container includes an inlet opening at the top and an outlet opening at the bottom. The inlet and outlet openings are sealed with valves that can be mechanically actuated using robotics. The container may include a non-stick inner surface, a vibration mechanism, and/or levitation technology.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Apparatus

A container for storing and transporting regolith includes an inlet opening at the top for adding regolith to the container and an outlet opening at the bottom for allowing regolith to be dispensed out of the container. The inlet and outlet openings may be sealed with valves that can be selectively opened and closed. The valves are preferably mechanically actuated so that the container can be opened and closed by mechanical interaction with a robot or other equipment. The lower portion of the container may taper inward, similar to a funnel, to facilitate the regolith flowing out of the container. The inner surface of the container may be a non-stick surface to prevent the regolith from adhering thereto.

In one embodiment, the regolith container is specifically designed for the efficient handling, storage, and transportation of regolith in low-gravity environments. In one example, the regolith container is designed as a cylinder. This cylindrical shape provides a straightforward design that facilitates easy storage and handling of regolith. The container comprises an interior reservoir used to store regolith material.

In this embodiment, the cylindrical container features two apertures: a first aperture located at the top of the cylinder, and a second aperture positioned at the bottom of the container. The first aperture serves as the primary entry point for regolith, allowing for the material to be loaded into the container. The second aperture serves as the exit point, facilitating the removal or unloading of the regolith from the container.

The regolith container is also designed with specific dimensions and features to ensure compatibility with external devices, such as a hauler and a brick making apparatus. The outer surface of the container may be shaped to fit snugly within a cavity of a hauler. The hauler is a specialized device designed to transport the container between different locations, specifically between a silo (where regolith is stored) and a brick making apparatus (where regolith is processed). In addition to the hauler, the container is also designed to fit into the cavity of a brick making apparatus or melter. This ensures that the regolith can be directly transferred from the container to the brick making apparatus for further processing. In one embodiment, the volume of the interior reservoir of the container is roughly similar to the volume that a brick making apparatus can accept.

While the described embodiments focus on a cylindrical design, it is understood that the container can take on various other shapes. The choice of shape would depend on specific requirements, compatibility with other devices, and ease of handling. A person of ordinary skill in the art would recognize that alternative shapes, such as rectangular, conical, or even custom-designed shapes, could be employed based on specific needs and constraints.

In essence, the invention provides a container with a design optimized for the handling and transportation of regolith. The container's shape, along with its apertures, ensures compatibility with external devices like haulers and brick making devices, facilitating a seamless process of regolith management in low-gravity environments.

The first aperture may be located on a first side of the container. In one embodiment, the first aperture serves as the primary entry point for regolith. The first aperture is dimensioned to facilitate easy and efficient transfer of regolith from a silo or other storage mechanisms into the container. The shape of the first aperture may be circular, oval, or any other shape that ensures a seamless transfer.

The material of the aperture may be resistant to abrasion, given the rough nature of regolith. It may be made of reinforced plastics, metals, or any other suitable material. The material of the aperture may be different from the material of the rest of the container. For example, the material of the aperture may be steel while the rest of the container is made of aluminum. In another example, the material of the aperture may be heat treated for increased resistance to abrasion and galling.

In one embodiment, the aperture is equipped with a sealing mechanism that prevents contamination from external sources and ensures that the regolith remains securely within the container during transportation. The first aperture may be sealed or closed with a first cap. This cap serves dual purposes: it prevents unwanted spillage or contamination of the regolith, and it provides an interface with a robotic system. The design of the first cap allows for a robotic arm or similar mechanism to securely grab, lift, and transport the container. The interface may include grooves, notches, or magnetic points tailored for robotic arms.

The second aperture may be located on a second side of the container. It is designed for the removal of regolith. The size of the second aperture is tailored to ensure a controlled and efficient flow of regolith into the brick making apparatus. Its shape may be designed to complement the funnel hopper of the brick making apparatus, ensuring a snug fit and minimizing spillage.

The second aperture may feature a coupling mechanism that allows it to mate or align perfectly with external devices like a funnel hopper. The coupling mechanism could be in the form of threads, latches, or magnetic couplings. Like the first aperture, the material for the second aperture is chosen for durability and resistance to abrasion.

In one embodiment, a second cap designed for secure closure may be securely coupled to the second aperture. In one embodiment, the cap can automatically open when the container is placed in a cavity of the brick making apparatus, ensuring a hands-free operation. In alternative embodiments, the cap can be removed or opened by a robot or other automated mechanisms.

The sealing mechanism of the container, particularly the first and second caps ensure a scal and robotic arm interface. The cap, whether it's a screw cap or a plug, provides a secure seal to prevent any spillage or contamination of the regolith. The cap's design allows for a robotic arm to securely grab and transport the container without inadvertently pulling the cap off. At the same time, the robotic arm should be able to intentionally remove the cap when required.

In one embodiment, the container may have a singular aperture that performs both functions of receiving and releasing regolith. Additionally, different mechanisms like magnetic locks, pressure-sensitive releases, or mechanical latches can be incorporated. In other alternative embodiments, the apertures may be positioned adjacently, at different angles, or on opposite sides based on specific requirements.

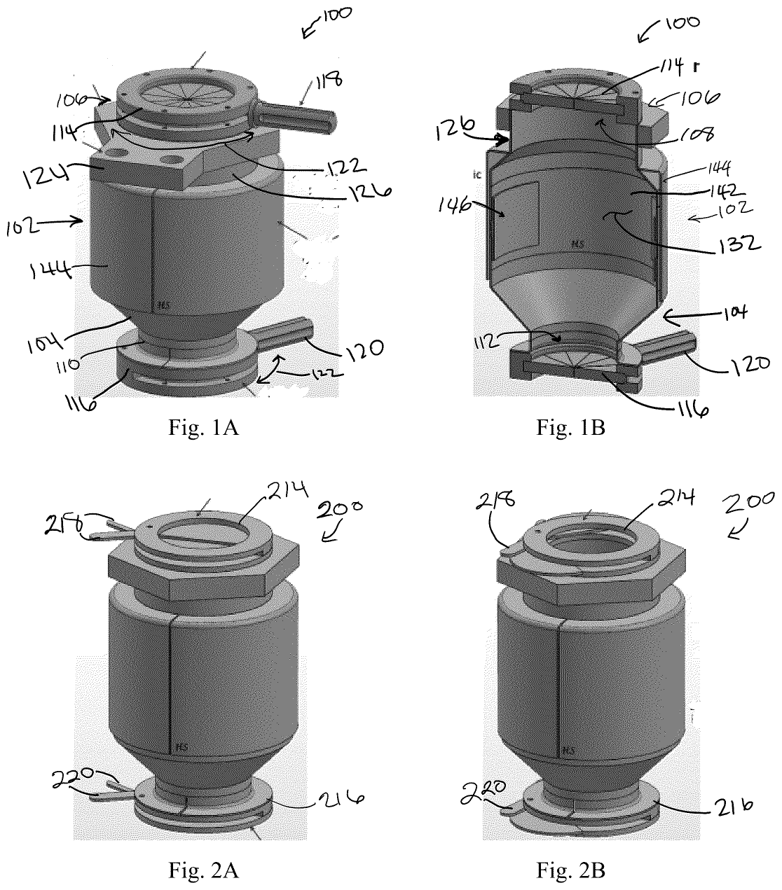

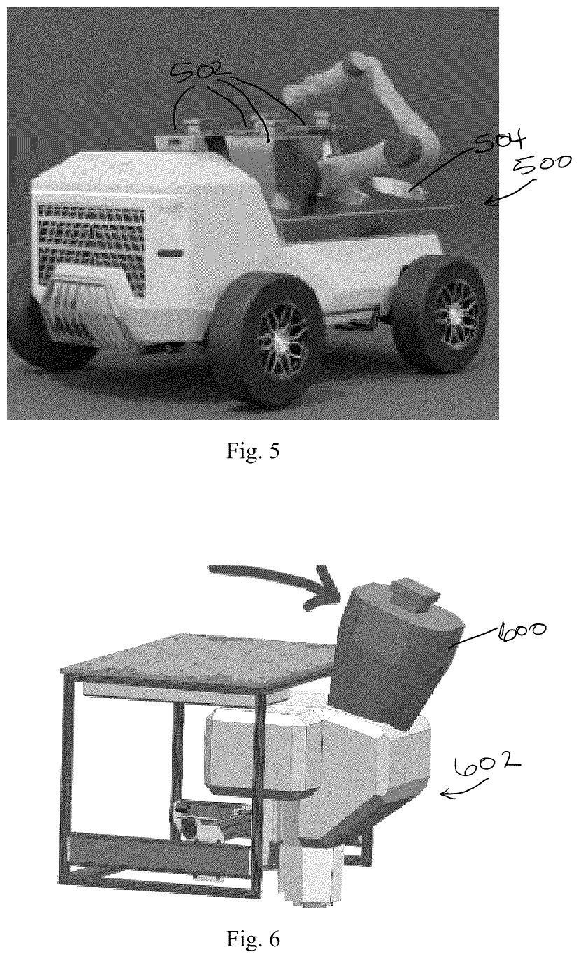

One example of a regolith container 100 in accordance with the present invention is shown in FIGS. 1A and 1B. The regolith container 100 includes an upper portion 102 and a lower portion 104 that is continuous with the upper portion 102. The lower portion 104 has sidewalls that slope inwardly. Although the upper portion 102 is depicted as having a cylindrical shape, the container 100 is not limited to having a cylindrical upper portion 102. Rather, the upper portion 102 can have any desired shape and may have a shape that is customized to be compatible with other equipment in the extraterrestrial environment. For example, FIGS. 5 and 6 illustrate regolith containers having upper portions with cross-sectional shapes that are square with rounded corners.

Similarly, the lower portion 104 is not limited to having the frustoconical shape illustrated in FIGS. 1A and 1B. Rather, the lower portion 104 may have any desired cross-sectional shape and may have a cross-sectional shape that is customized to be compatible with other equipment. For example, the lower portion 104 may have a cross-sectional shape that is round, square, triangular, square with rounded corners, or the like. Regardless of the cross-sectional shape, the lower portion 104 tapers inwards so that the regolith is funneled towards a bottom opening 112. The angle of the lower portion 104 may be optimized to facilitate the flow of regolith out of the container 100. In one example, the angle of sidewalls of the lower portion 104 is between 30 and 60 degrees, or between 40 and 50 degrees.

The upper portion 102 of the container 100 has a top end 106 having an inlet opening 108. Regolith can be added to the container 100 through the inlet opening 108. The lower portion 104 of the container 100 has sidewalls that taper inwards and terminate in a bottom end 110 having an outlet opening 112. Regolith is dispensed out of the container 100 through the outlet opening 112.

The inlet opening 108 and the outlet opening 112 each include a sealing mechanism that prevents contamination from external sources and ensures that the regolith remains securely within the container 100 during transportation. In the example shown in FIGS. 1A and 1B, the sealing mechanisms are valves 114, 116 attached to the openings 108, 112. The inlet valve 114 and the outlet valve 116 are configured to move between a closed position (as shown in FIGS. 1A and 1B) and an open position. The valves 114, 116 may be mechanically actuated to facilitate using a robot to open and close the valves 114, 116. In the example shown in FIGS. 1A and 1B, the valves 114, 116 are iris style valves that are operated by moving the handles 118, 120 clockwise or counter-clockwise, as shown by the arrow 122. In one example, the valves 114, 116 are biased to be in the closed position. For example, the valves 114, 116 may be spring loaded to be in the closed position and the force of the spring is overcome by moving the handle 118, 120 to open the valve 114, 116. When the handle 118, 120 is released, the spring forces the valve 114, 116 back to the closed position.

The container 100 further includes a robotic arm interface configured for allowing a robotic arm or similar mechanism to securely grab, lift, and transport the container 100. The robotic arm interface may include grooves, notches, or magnetic points tailored for robotic arms. For example, the container 100 may include a protruding tab 124 that can be gripped by a robot. Additionally or alternatively, the container 100 may include a peripheral notch or collar 126 that can be gripped by a robot. The container is not limited to the protruding tab 124 and/or the collar 126. It will be readily understood that the container 100 may include any other type of robotic arm interface.

As shown in FIG. 1B, the container 100 includes an inner surface 132 that comes into direct contact with the regolith. The inner surface 132 may be smooth to minimize friction and facilitate easy movement of regolith. The interior reservoir may be coated with a liner or a material that either lacks electrostatic properties or has been treated in such a way that it minimizes static buildup. This reduces the likelihood that the regolith will stick to the container's interior 132. To further enhance the flow of regolith, the interior surface 132 of the container 100 may be coated with a non-stick material such as polytetrafluoroethylene. This ensures that regolith slides easily within the container without adhering to its walls. In other examples, the inner surface 132 may be coated with a different non-stick coating (such as ceramic or the like), made of a non-stick material, or have a surface treatment (e.g., microfinishing) that causes the inner surface 132 to have non-stick properties. Given the need for transportation, especially in extraterrestrial environments, the material used for the container may be lightweight, including, but not limited to carbon-fiber due to its strength-to-weight ratio.

The container 100 may include an inner shell 142 and an outer shell 144. The outer shell 144 may be sized and shaped to be compatible with other equipment, such as a transportation cartridge, a brick making apparatus, or the like. The inner shell 142 may be sized and shaped to be compatible with regolith. For example, the tapered sidewalls in the lower portion of the inner shell 142 may have a predetermined angle that is optimized for regolith flow. The lower portion of the outer shell 144 may have an angle that is the same or different from the angle of the lower portion of the inner shell 142. The angle of the lower portion of the outer shell 144 may be optimized to be compatible with other equipment (such as a hauler or a brick making apparatus). The inner shell and outer shell may be made of the same materials or different materials. For example, the outer shell may be made of a material that is compatible with the lunar environment while the inner shell may be made of a material that is non-stick and resistant to abrasion.

As shown in FIG. 1B, the inner surface of the container 100 may include a levitation mechanism 146 that is used to suspend the regolith particles within the container 100 and to regulate the flow of regolith out of the container 100. The levitation mechanism is discussed in greater detail below.

The container 100 may further include a vibration mechanism that causes the container 100 to vibrate in order to facilitate dispensing regolith out of the outlet opening 112 of the container 100. The vibration mechanism may be selectively activated when regolith is being dispensed out of the container. In one example, the vibration mechanism is configured to turn on automatically when the container 100 is attached to the brick making apparatus and/or when the lower valve 116 is in the open position. The vibration mechanism may be a vibration motor such as an eccentric rotating mass vibration motor.

The container 100 may additionally include an agitator for preventing clumping of the particles inside the container 100. In one example, a vibration motor attached to the inner surface 132 of the container 100 may act as an agitator. Power to the agitator and/or the vibration mechanism may be supplied through an electrical interface when the container 100 is attached to another piece of equipment, such as the brick making apparatus.

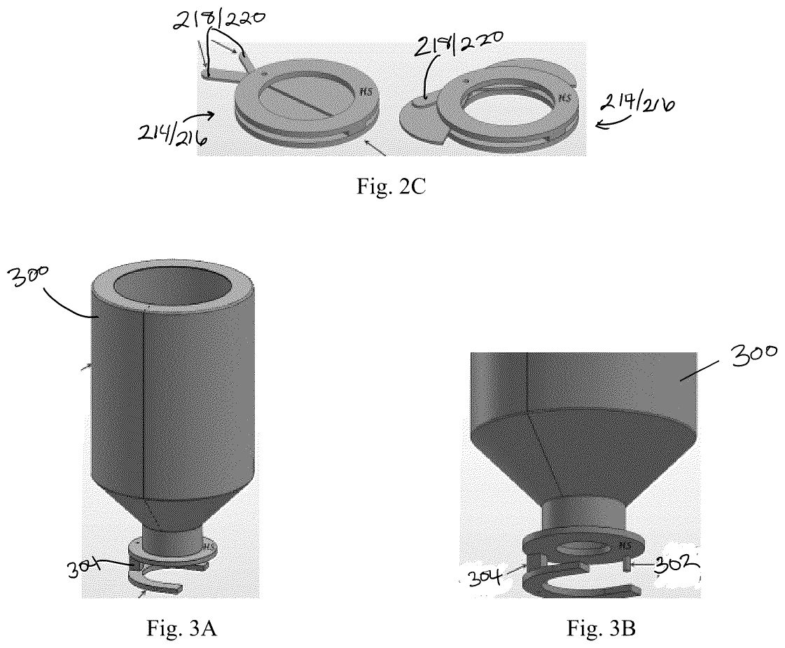

In another example, shown in FIGS. 2A-2C, the upper valve 214 and the lower valve 216 are scissor valves that are operated by moving the handles 218, 220 towards each other or away from each other. FIG. 2C depicts the valves 214, 216 in the closed and open position. The container 200 shown in FIGS. 2A and 2B is substantially similar to the container 100 shown in FIGS. 1A and 1B, except that the sealing mechanism on the inlet and outlet are scissor valves rather than iris valves. It will be readily apparent to a person of ordinary skill in the art that the upper valve and the lower valve may be the same type of valve or may be different from each other.

The iris valves illustrated in FIGS. 1A and 1B and the scissor valves illustrated in FIGS. 2A and 2B are merely examples of types of valves that can be used in accordance with various embodiments of the container. These are not presented as an exhaustive set of valve types, and thus it will be understood that other suitable valves can be used to seal the container 100, 200.

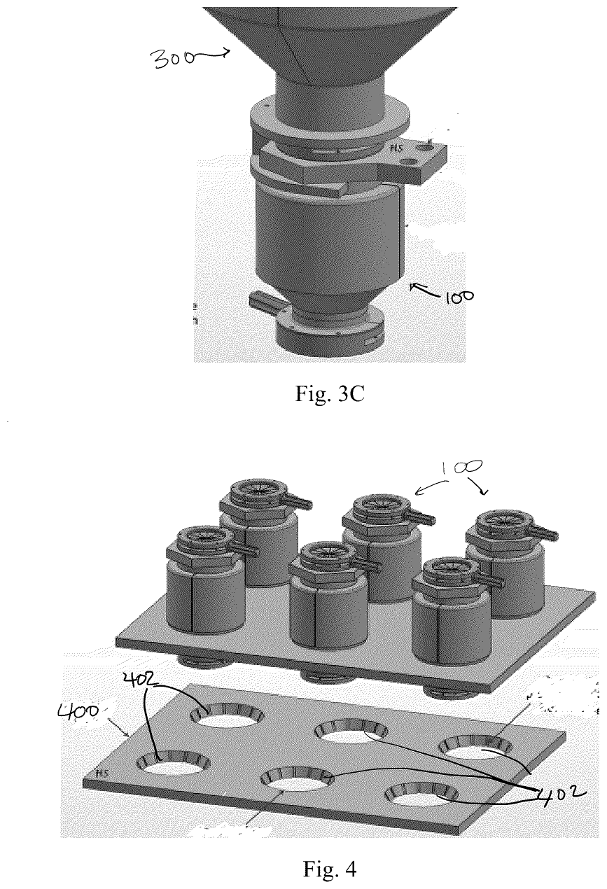

FIGS. 3A and 3B illustrate a silo 300 configured to add material to the container 100, 200. The silo 300 may include a valve actuating mechanism. For example, the silo 300 may include a vertical bar 302 that moves the handle of the valve as the container 100, 200 is being docked with the silo 300. Additionally or alternatively, the silo 300 may include a scissor valve actuating mechanism 304 that is configured to cause the scissor valve to open when the container 200 is docked with the silo. FIG. 3C depicts the container 100, 200 docked with the silo. In this configuration, material from the silo can be dispensed into the container 100, 200 for transporting to another location. When the container 100, 200 is removed from the silo 300, the inlet valve automatically returns to the closed position.

When the container is transported, especially over rough terrain, it is essential that the container remains securely in place within its holder or cartridge. In one embodiment, the exterior shell helps the container fit snugly within its holder to prevent it from bouncing around or falling out during transportation. In one embodiment, the exterior shell design minimizes stress on the container, ensuring its longevity and preventing any potential damage.

FIG. 4 is an example of a crate 400 that can be used to transport a plurality of containers 100, 200. The containers 100, 200 are held in the crate 400 in a predetermined configuration that maximizes the number of containers 100, 200 that can be held by the crate 400. In one example, the crate may include apertures, openings, or cavities 402 that mimic the outer shape of the container 100, 200 so that the container 100, 200 can be securely held in place and can be easily placed within and removed from the crate 400. The crate 400 may be configured for preventing the containers 100, 200 from seizing or getting stuck in the cavities 402. For example, the cavities 402 may include vertical grooves around the periphery and/or the angle of the cavities 402 may be slightly different from the angle of the outer surface of the container 100, 200 so that the entire surface of the cavity 402 is not in direct contact with the outer surface of the container 100, 200. In other words, there may be slight gaps between the cavities 402 and the containers 100, 200 to prevent the containers 100, 200 from seizing or getting stuck to the crate 400.

FIG. 5 is an example of a hauler 500 for transporting a plurality of regolith containers 502. The hauler 500 includes a respective plurality of cavities 504 that are sized and shaped to hold regolith containers 502 therein. The size and shape of the cavities 504 in the hauler 500 mimics the size and shape of the lower portion of the containers 502 so that the containers 502 fit snugly within the hauler 500 and are prevented from being jostled around or falling out of the hauler 500.

FIG. 6 illustrates an exemplary embodiment of a regolith container 600 being used with a brick making device 602. The regolith from the container 600 is added to the brick making device 602 in order to make bricks out of the regolith. In this particular illustration, the regolith container 600 is placed within a feedstock cavity of the brick making device 602. As such, the feedstock cavity and the outer surface of the lower portion of the regolith container 600 may be similar in size and shape.

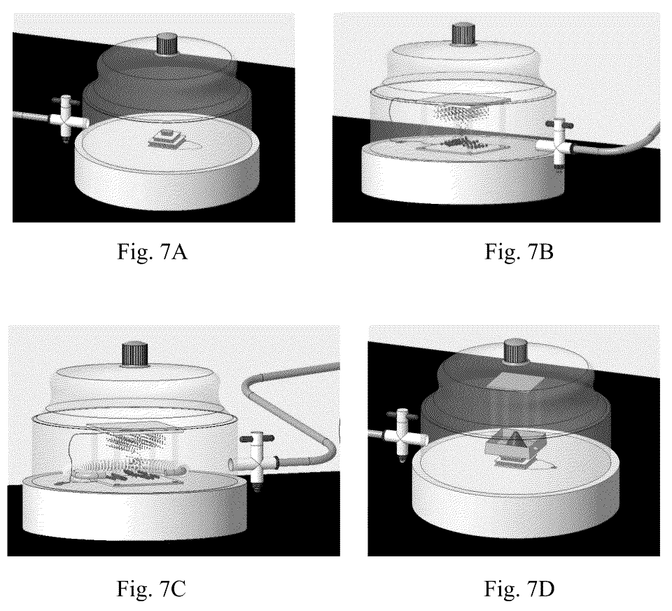

FIGS. 7A-7D illustrate exemplary electromagnetic systems. In one embodiment of the invention, a chamber may be formed within the interior reservoir of the regolith container. The chamber is designed to create a controlled environment where external atmospheric conditions can be isolated, ensuring that the regolith remains unaffected by external pressures or contaminants. One aspect of the design of the interior reservoir is the incorporation of levitation technology. In one embodiment, the levitation technology is employed to suspend the regolith particles within the container or the interior reservoir. By doing so, the particles are prevented from settling at the bottom, ensuring a uniform distribution and facilitating easier transportation and extraction. The levitation mechanism can also be adjusted to control the flow of regolith into and out of the container. This provides precise control over the amount and rate of regolith being loaded or unloaded.

One implementation of the levitation technology may include embedded electromagnetic nodes within the interior reservoir. These nodes serve the function of generating the electromagnetic fields required for the levitation technology to operate. In one embodiment, the container may include a power source to supply power to the electromagnetic node. This ensures that the electromagnetic fields remain stable and can effectively levitate the regolith particles.

In one embodiment, the interior of the container is lined with one or more electromagnetic plates. These plates can be activated to levitate a portion of the regolith particles. The design may incorporate multiple plates, strategically positioned to optimize the levitation and flow of regolith.

In one embodiment, an inducer mechanism may be integrated into the design of the container. This inducer is primarily constructed from a material that, when charged, becomes magnetic. The inducer serves to activate levitation or movement. When a charge is applied to the inducer, it activates the material's magnetic properties, causing the regolith particles to levitate. The inducer can be adjusted to control the flow of regolith, directing it through a funnel or similar structure for precise loading or unloading.

In another embodiment, the container walls themselves become electrified, inducing levitation. The walls could be constructed from a material that, when charged, exhibits magnetic properties. This design simplifies the levitation process by eliminating the need for separate electromagnetic nodes or plates. Instead, the entire interior surface of the container becomes the levitating mechanism.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A container for storing and transporting regolith, the container comprising:
an upper portion comprising a top end having an inlet opening;
a lower portion continuous with the upper portion, the lower portion comprising sidewalls that taper inwards and terminate in a bottom end having an outlet opening;
an inlet valve attached to the inlet opening, the inlet valve configured for moving between a closed inlet position and an open inlet position;
an outlet valve attached to the outlet opening, the outlet valve configured for moving between a closed outlet position and an open outlet position; and
a robotic arm interface configured for being gripped by a robot.

2. The container of claim 1, wherein the inlet valve and the outlet valve are mechanically actuated valves.

3. The container of claim 2, wherein the inlet valve and the outlet valve are iris valves or scissor valves.

4. The container of claim 2, wherein the inlet valve comprises an inlet valve actuator and the outlet valve comprises an outlet valve actuator, wherein the inlet valve actuator and the outlet valve actuator comprise handles that are configured for being operated by a robot or by mechanical engagement with other pieces of equipment.

5. The container of claim 1, further comprising an inner surface having a non-stick coating.

6. The container of claim 5, wherein the non-stick coating is polytetrafluoroethylene.

7. The container of claim 1, wherein the inlet valve and the outlet valve are biased to be in the closed inlet position and the closed outlet position, respectively.

8. The container of claim 1, further comprising a vibration mechanism configured to be selectively activated to cause the container to vibrate.

9. The container of claim 1, further comprising an agitator for preventing material inside the container from clumping.
